(19) United States
(12) Patent Application Publication
(10) Pub. No.: US 2005/0109739 A1
(43) Pub. Date: May 26, 2005

(54) Gas generator for a sterilizing system

(76) Inventors: Philippe Destrez, Meudon (FR); Jean-Pierre Maillot, Les Essarts-Le-Roi (FR); Michel Fesquet, Antony (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/506,310

(22) PCT Filed: Mar. 3, 2003
(86) PCT No.: PCT/FR03/00669

(30) Foreign Application Priority Data
Mar. 4, 2002 (FR) 02/02718

(51) Int. Cl. B23K 9/00

(52) U.S. Cl. 219/121.54

(57) ABSTRACT

Plasma generation system comprising a high voltage generator (20) connected to at least two electrodes (26, 28), one having a large radius of curvature, or having a plane geometry, and the other having a small radius of curvature, this high voltage generator being controlled (32, 34, 36) in such a way as to maintain constant the mean frequency of occurrence of the current discharges between the electrodes.

### TECHNICAL FIELD

The present invention relates to a plasma sterilization system operating at ambient pressure and temperature, and more particularly it relates to a plasma gas generator for such a system.

### PRIOR ART

A certain number of disinfection or sterilization systems operating on the basis of a biocidal gas derived from a plasma gas are in existence at the present time. Many of these systems make use of complex vacuum generation devices.

In patent application WO 00/54819 filed under the name of the present applicant, the inventors proposed a novel sterilization process at atmospheric pressure and at ambient temperature, using a plasma in post-discharge mode. This process, which is entirely satisfactory, operates on the basis of a mixture of non-biocidal gases (air, for example), with sterilization taking place in the presence of moisture. However, with this configuration it is difficult to evaluate the efficacy of the sterilizing gas. Knowledge of this factor is essential if constant sterilization quality is to be achieved over time.

A special sensor, targeted on one particular gas, can be developed if required to monitor the presence of this gas in the sterilization area, and thus indirectly to monitor the efficacy of the sterilizing gas. However, such special sensors are expensive and can only monitor part of this sterilizing gas.

It is also possible to carry out a wide-spectrum chemical analysis in the discharge or at the output of the plasma source, requiring the use of complex and costly apparatus, such as a mass spectrometer (MS) or a gas chromatograph (GC), as described in the article by Zoran Falkenstein, “Ozone Formation with (V)UV-Enhanced Dielectric Barrier Discharges in Dry and Humid Gas Mixtures of O2, N2/O2, and Ar/O2”, published in the journal “Ozone Science And Engineering, Vol 21, 1999, p.583-603”. However, the slow measurement rate of this apparatus considerably limits its use.

It is also possible to provide for rapid acquisition of the electrical signal passing through the source and to integrate the mean signal, but this requires acquisition and calculation systems which are particularly fast and therefore costly. This is because the useful signals to be analyzed are of the order of a few nanoseconds, and require the use of an acquisition and flow rate analysis having a sampling rate of more than 500 MHz, as stated in the article by O. Motret, C. Hibert, M. Nikravech, I. Gaurand, R. Viladrosa and J. M. Pouvesle, “The Dependence of Ozone Generation Efficiency on Parameter Adjustment in a Triggered Dielectric Barrier Discharge”, published in the journal “Ozone Science And Engineering, Vol 20, 1998, p.51-66”.

### OBJECT AND DESCRIPTION OF THE INVENTION

The object of the present invention is a plasma generation system which enables the efficacy of the sterilizing gas to be ensured by means of a simple and economical measurement.

The invention proposes a plasma generation system comprising a high voltage generator connected to at least two electrodes, one having a large radius of curvature (and preferably a plane geometry) while the other has a small radius of curvature, characterized in that said high voltage generator is controlled in such a way as to maintain constant the mean frequency of occurrence of current discharges from the at least one electrode with a small radius of curvature to the at least one electrode with a large radius of curvature.

If the high voltage generator is a sinusoidal or pulsed alternating generator, the plasma generation system advantageously comprises a dielectric insulator inserted between the electrodes. Depending on the type of generator, said high voltage generator can comprise a high gain transformer driven by a transistor operating in switching mode under the control of a low voltage signal generator having a specified fixed frequency and a variable mark-space ratio (in the case of a sinusoidal alternating high voltage generator), or can comprise a high voltage chopper distributing alternately a positive continuous high voltage and a negative continuous high voltage to the at least one electrode with a small radius of curvature under the control of a low voltage signal generator having a specified fixed frequency and a variable mark-space ratio (in the case of a pulsed high voltage generator).

If the generator is a continuous high voltage generator, it can comprise a rectifying circuit connected at the output of a high gain transformer driven by a transistor operating in switching mode under the control of a low voltage signal generator having a specified fixed frequency and a variable mark-space ratio.

Depending on the envisaged mode of implementation for measuring a signal representing the current discharges from the at least one electrode with a small radius of curvature to the at least one electrode with a large radius of curvature, it may comprise a resistance connected between an earth potential and the at least one electrode with a large radius of curvature, or a current transformer connected in the electrical circuit supplying the electrodes.

Preferably, it also comprises a high pass or low pass filter so that only the part of the measured signal representing the discharges appearing between the electrodes is recovered. The measured and filtered signal is then converted by a conversion system, during a specified fixed period, into a specified continuous voltage representing a mean number of electrical discharges, and this mean number of discharges is controlled by a control system to match a specified set value corresponding to said mean frequency of occurrence of the current discharges.

The invention also relates to any plasma sterilizing system operating in the presence of moisture, at atmospheric pressure and at ambient temperature, using the aforementioned plasma generation system.

### BRIEF DESCRIPTION OF THE DRAWINGS

The invention will be more clearly understood from the following description, provided for guidance and without restrictive intent, with reference to the attached drawings, in which:

FIG. 1 is a schematic diagram of a plasma sterilization system,

FIG. 2 is a schematic diagram of a plasma generation system according to the invention, applied in the sterilization system of FIG. 1,

FIG. 3 is a first example of embodiment of the plasma generation system of FIG. 2 operating with an alternating high voltage,

FIG. 4 shows two curves relating a mean number of discharges and the amplitude of the high voltage to the mark-space ratio of a low voltage control generator,

FIGS. 5a to 5d are oscillograms showing electrical measurements made at particular points of the system of FIG. 3,

FIG. 6 shows a variant embodiment of the current measurement system based on a current transformer,

FIG. 7 shows a first variant embodiment of the plasma generation system of FIG. 2 in which the high voltage is continuous,

FIG. 8 shows a second variant embodiment of the plasma generation system of FIG. 2, in which the high voltage is pulsed,

FIGS. 9a to 9c are oscillograms showing electrical measurements made at particular points of the system of FIG. 8, and

FIG. 10 is a diagram showing the distribution of the quantity of charge over time in the plasma generation system of the invention.

### DETAILED DESCRIPTION OF EMBODIMENTS

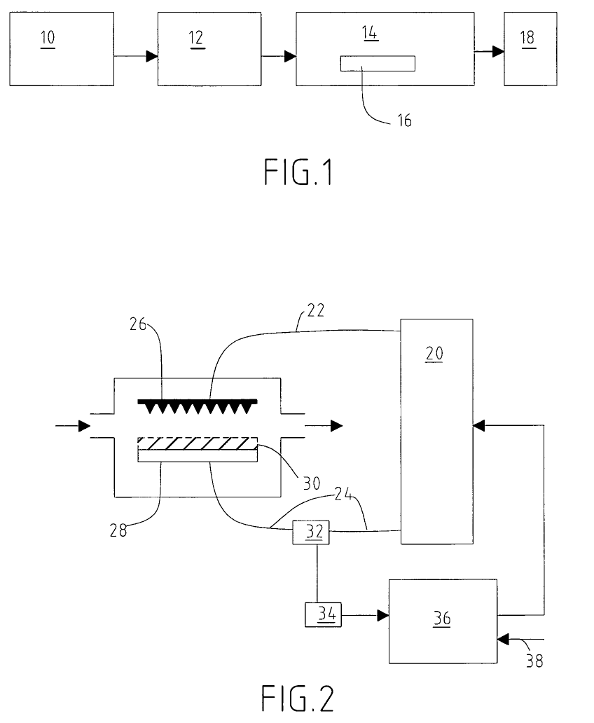

FIG. 1 shows a schematic diagram of a plasma sterilization system. In such a system, a source of non-biocidal gas 10 injects non-biocidal gas into a plasma generation system 12 which generates a biocidal plasma from the non-biocidal gas and injects the sterilizing biocidal gas formed in this way into a treatment area 14 containing the object or objects to be sterilized 16. The gas emerging from this area is discharged to the exterior, preferably after passing through a system 18 for filtering harmful residues. The treatment area is sealed and subjected to ambient temperature and pressure. The biocidal gas contained in the treatment area must have a relative humidity of more than 50%. This can be achieved either by humidifying the non-biocidal gas during its generation, or directly by injecting a moist gas (advantageously the same non-biocidal gas) into the treatment area. The plasma generation system 12 may or may not be (wholly or partially) separated from the treatment area 14.

In such a plasma sterilization system, illustrated for example in the international patent application cited in the preamble, discharges must be created between the electrodes, but without reaching electrical arc conditions, in order to produce the sterilizing gas. This production of discharges is the function of a plasma generator which applies a high voltage between the electrodes and which also has the task of ensuring the quality of the sterilizing gas resulting from these discharges. The natural wear of the electrodes and the variations, even if small, of geometry between one electrode and the other can lead to considerable variations in sterilizing efficacy. To ensure constant efficacy, it is therefore important to lock the plasma generator to a parameter which is independent of these phenomena, and not, for example, to the amplitude of the high voltage applied between the electrodes, which has proved to be an unsatisfactory control parameter.

This is why the inventors propose to lock the plasma generator to the quantity of energy transmitted to the gas during the inter-electrode discharges. However, since it is not easy to measure this quantity of energy directly, the inventors propose that the current discharges passing through the electrode supply circuit be counted over a period whose duration is considerably greater than the mean time between two electrical discharges.

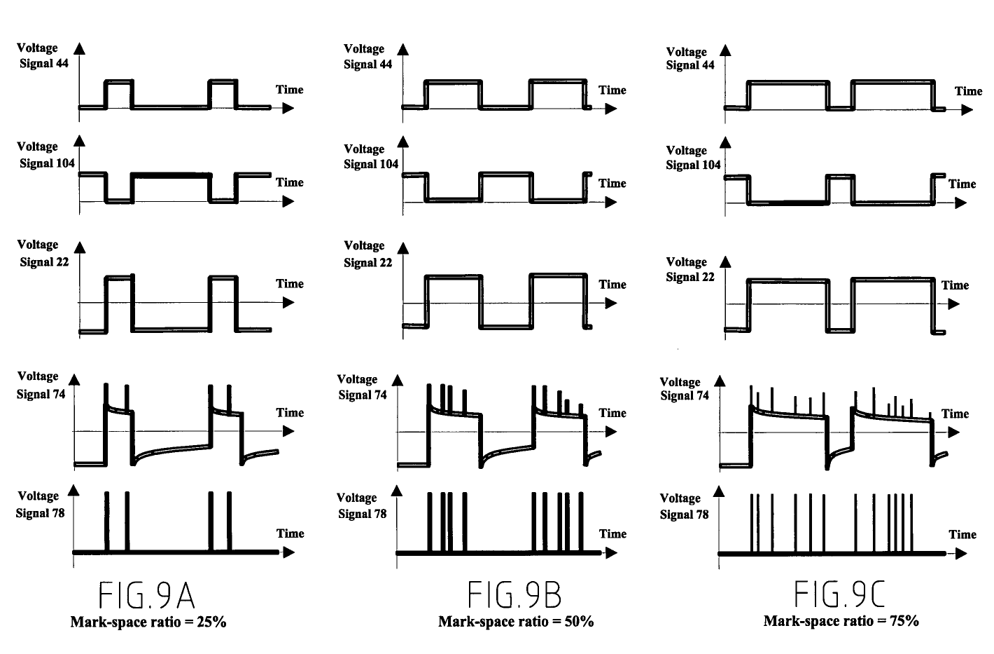

This is because the mean value of the electrical charges of the set of electrical discharges occurring between the electrodes in a given time is constant. Furthermore, the occurrence of these discharges is regular over time when the amplitude of the inter-electrode voltage is constant. This finding is illustrated by experimental results of measurements of the distribution of the quantity of charge passing through the inter-electrode space, made by the inventors with a prototype sterilization system, and shown in the diagram of FIG. 10.

The test was carried out over 70 discharges, in other words for a period of 500 μs according to our experience. It was found that most of the current discharges were between 0.30 nC and 0.60 nC.

It can be deduced from this that the counting of these current discharges over a period whose duration is considerably greater than the mean time between two discharges is sufficient for the evaluation of the total charge which has passed through the inter-electrode space during the same period, and consequently the energy transferred to the gas during this period. This is because the following equation is applicable:
Ct=Nb*Cm
Ct: Total charge of discharges per unit of time.
Nb: number of discharges per unit of time.
Cm: Mean charge of a discharge.

To illustrate the above, the following table shows the sterilizing behaviour of a prototype sterilization system operating according to the principle of the invention, for the case of sterilization of spores of Bacillus subtilis.

The heading “number of discharges” corresponds to the mean number of discharges per period of the alternating high voltage signal applied between the electrodes, and the efficacy is given in decimal reduction times, in other words the time required to divide a population of spores by 10. These results are given for different operating configurations of the sterilization system:

Configuration 1: gas flow rate=2 1/min, inter-electrode distance 2 mm.

Configuration 2: gas flow rate=8 1/min, inter-electrode distance 2 mm.

Configuration 3: gas flow rate=4 1/min, inter-electrode distance 0.6 mm.

| | No. of | Decimal reduction time |
|---|---|---|
| Configuration | discharges | (mins.) |
| 1 | 8 | 5.8 |
| | 12 | 4.5 |
| | 16 | 3 |
| 2 | 8 | 8.7 |
| | 16 | 2.5 |
| 3 | 8 | 3 |
| | 16 | 2.1 |

Thus it has been found that the speed of sterilization increases with the number of discharges in each configuration. It will also be noted that these measurements, which were obtained by a number of successive tests, showed acceptable reproducibility between tests.

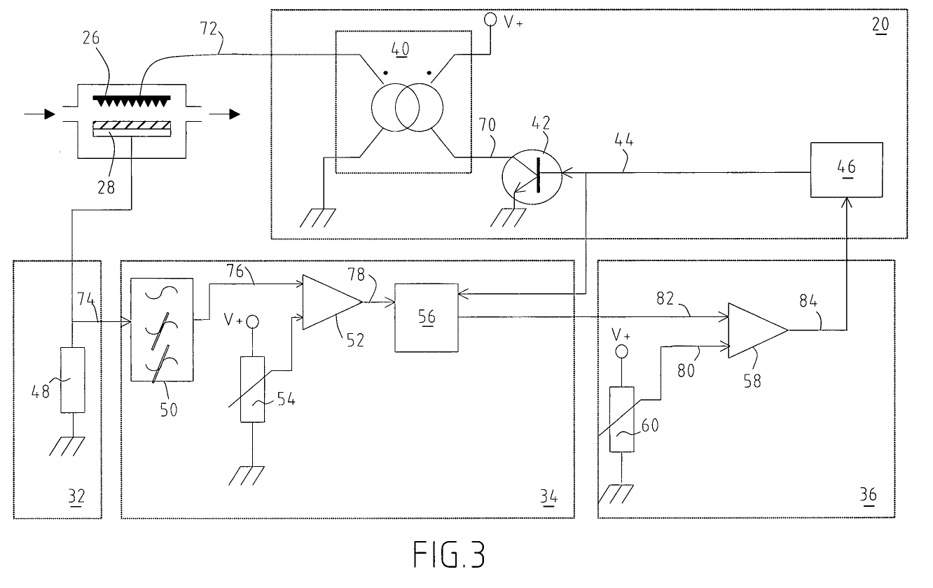

A schematic view of a plasma generation system implementing the above principle is given in FIG. 2. It is based on a high voltage generator 20 which supplies two electrodes through two electrical conductors 22, 24, each electrode having a very different radius of curvature, to produce an electrical discharge called a “corona” discharge between the electrodes. The electrode with a small radius of curvature 26 is typically a wire or blade provided with points, and the electrode with a large radius of curvature 28 is a flat surface.

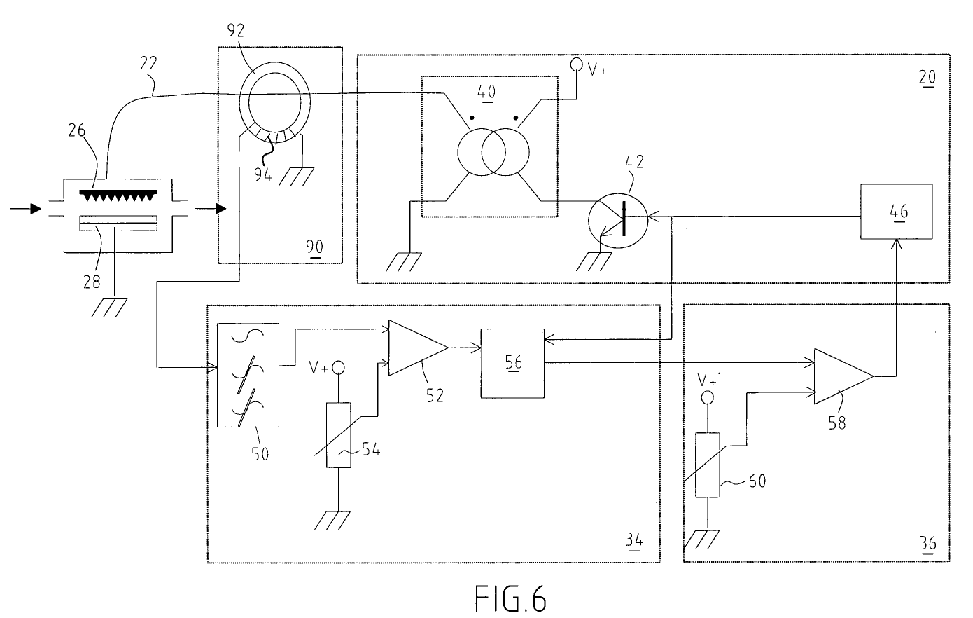

When the generator is a sinusoidal or pulsed alternating generator, and a dielectric insulator 30 is inserted between the two electrodes (for example so that it covers the flat electrode as illustrated), the plasma discharge is said to be of the DBD type (Dielectric Barrier Discharge). With this plasma discharge configuration, it is possible, in particular, to retard the change to the electric arc and to increase the energy transfer to the gas, as compared with a configuration without an insulator using a continuous generator (this configuration is shown in FIG. 7).

A current measurement system 32 is connected in series with the electrical conductor 24 in the high voltage path. The measured current, or the equivalent voltage, is converted by a conversion system 34, over a specified fixed period, to a mean number of electrical discharges. A control system 36 then calculates a control signal for the voltage generator 20 in such a way as to keep this measured mean number of discharges as close as possible to a set value 38 specified by the user and corresponding to a desired frequency of occurrence of discharge.

This creates a control loop which adjusts the amplitude of the high voltage in such a way as to maintain constant the mean frequency of occurrence of the current discharges. If the controller input voltage is greater than the set voltage 38, this means that the mean frequency of occurrence of the discharges is too high, and the controller output voltage then decreases linearly until the input voltage and the set voltage are equal. In the converse case, where the input voltage is less than the set voltage, this means that the mean frequency of occurrence of the discharges is too low, and the controller output voltage increases linearly until these two voltages are again equal.

An implementation of this type is particularly appropriate because it has been found that the mean number of discharges over a given time can be controlled by varying the amplitude of the high voltage applied between the electrodes, the control being provided according to the law: Increase of the amplitude of the high voltage−>increase of the number of discharges, decrease of the amplitude of the high voltage−>decrease of the number of discharges.

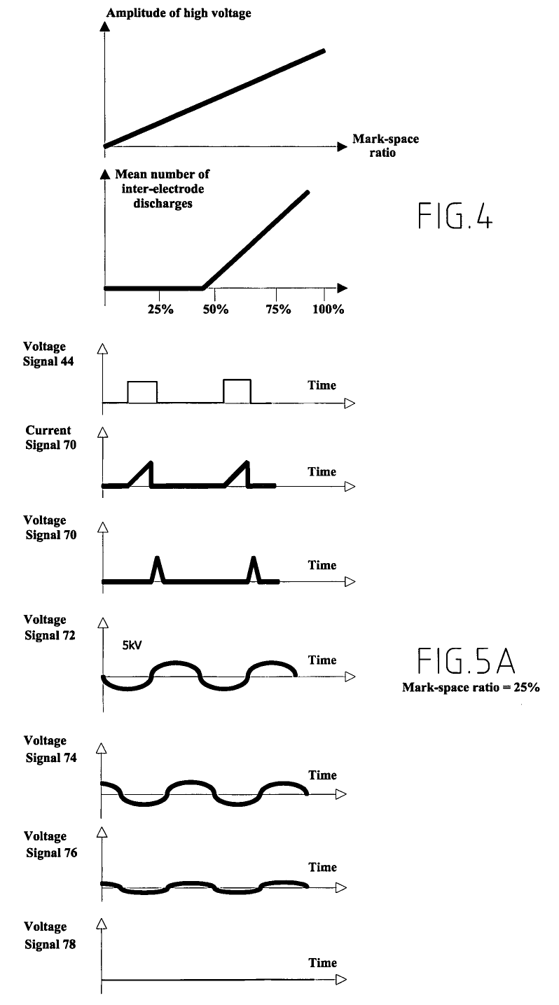

A preferred example of embodiment of the plasma generation system based on a sinusoidal alternating high voltage is shown in detail in FIG. 3. The alternating high voltage generator 20 consists of a transformer 40, typically a high gain transformer, driven by a transistor 42 operating in switching mode. The control signal 44 of the transistor is calculated by a rectangular signal generator 46 having a fixed frequency and variable mark-space ratio. The fixed frequency of this generator is calculated to coincide with the resonant frequency of the transformer/plasma source assembly. The mark-space ratio of the signal generator is controlled by the output signal of the control system 36.

The system 32 for measuring the current passing through the inter-electrode space consists of a simple resistance 48 across whose terminals is sampled a voltage proportional to the current which constitutes the input signal of the conversion system. This conversion system 34 comprises a high pass filter 50 to remove all low-frequency components from this input signal and keep only the high frequency components resulting from the discharges between the electrodes. It will be noted that it is also possible to use a more or less selective band pass filter, in order to recover only the useful components of the signal, and particularly in order to remove the various parasitic components and perturbations which may appear.

The resulting signal at the output of the filter then passes through a comparator 52 which detects the exceeding of a specified variable threshold, determined by a threshold potentiometer 54, and delivers in logical form the current discharges exceeding this threshold. This logic signal is injected into a binary counter (or frequency meter 56) which is synchronized on the transistor control signal 44 and which stores in the form of a continuous voltage (by means of a sample and hold unit) a value of the count per measurement period. Synchronization is carried out so that a mean frequency of occurrence of the discharges is calculated for a specified fixed period corresponding to a multiple (for example 16 times) of the control signal period. The output voltage of the frequency meter, representing the frequency of occurrence of the discharges, is introduced into the control system 36 consisting of a comparator 58 which compares the output voltage with a set voltage provided by a set point adjustment potentiometer 60. The output of the comparator acts as the control signal for the control of the mark-space ratio of the rectangular signal generator 46 and thus for the adjustment of the high voltage at the transformer 40 (via the switching transistor 42).

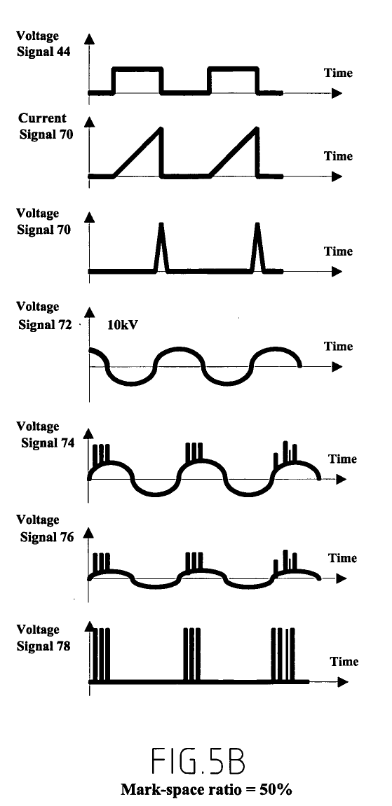

The control of the mark-space ratio as a function of this control signal, which is used to adjust the amplitude of the high voltage, is linear, as shown by the curve 62 of FIG. 4. This signal is minimum for a mark-space ratio of 0% and maximum for a mark-space ratio of 100%. Additionally, the curve 64, which shows the relationship between the mark-space ratio and the mean number of discharges per cycle of the signal appearing between the electrodes, indicates that the open-loop gain of the controller is considerable, demonstrating the value of controlling according to the mean number of discharges and not according to the amplitude of the high voltage.

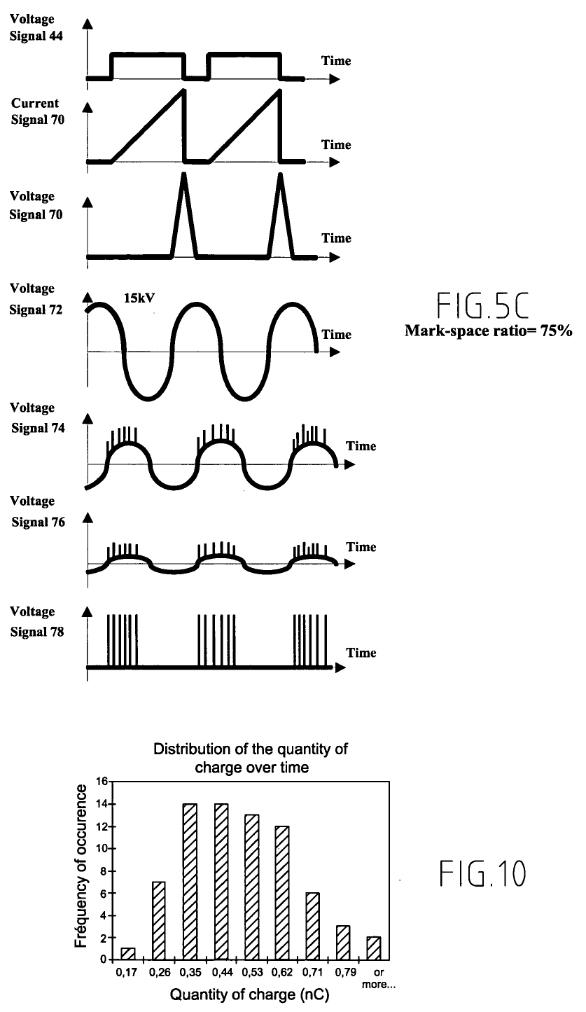

The operation of the plasma generation system will now be explained with reference to FIGS. 5a to 5d, which show the variations of voltage and current in this generator for different mark-space ratios of the control signal.

On the oscillograms of FIG. 5a, the control signal 44 of the transistor 42 has a mark-space ratio fixed at 25%. The current induced across the primary of the transformer 40 conventionally follows the law of behaviour of an inductance, U=−L di/dt, and therefore a linear progression of the current is observed at the output 70 of the transistor when the transistor is saturated, after which, when the control signal 44 returns to zero voltage, with the transistor switching to a locked state, this current falls abruptly to a zero value. This abrupt fall results in a considerable increase of voltage at the output 70 of the transistor, which may reach 100 V for a power supply of several tens of volts (30 V for example). This voltage peak on the primary of the transformer induces high voltage at the output 72 of the secondary which, in the aforementioned conditions and depending on the gain of the transformer, can reach 5 kV peak-to-peak.

Finally, it will be noted that the choice for the control signal 44 of a frequency equal to the resonant frequency of the transformer/plasma source assembly makes it possible to have a high voltage output signal 72 of quasi sinusoidal shape. The measurement of the voltage 74 across the terminals of the resistance 48 shows, because of the capacitive behaviour of the source, a sinusoid shifted by 90° which is found again, after passing through the filter 50, on an input terminal 76 of the comparator 52. However, for this mark-space ratio, the transformer output voltage is not high enough to produce electric discharges, and the comparator does not detect anything and therefore supplies a zero voltage at its output 78.

On the oscillograms of FIG. 5b, the control signal 44 has a mark-space ratio fixed at 50%. Clearly, the current (in 70) flowing through the primary of the transformer 40 now reaches higher values than in the preceding case, as well as the voltage (in 70) on the same primary. Logically, the output voltage 72 of the transformer reaches a value greater than that of the preceding example, in this case 10 kV peak-to-peak. In this case, the voltage measurement at the terminals of the resistance shows the appearance of electrical discharges in the form of voltage peaks. After filtering 50, the comparator 52, whose threshold value fixed by the potentiometer 54 has now been exceeded, detects the existing discharges (i.e. approximately 3 per period in the example shown).

Finally, on the oscillograms of FIG. 5c, the control signal 44 has a mark-space ratio fixed at 75%. As before, the increase of the mark-space ratio causes an increase in the output voltage 72 of the transformer 40, for example 15 kV peak-to-peak, and the number of discharges detected by the comparator 52 is greater than before, being equal to 6 per period in this case, for example.

The variation of the signals in the control system 36 during the start-up of the system is shown on the oscillograms of FIG. 5d. To make these oscillograms more readable, the conversion system 34 is synchronized on twice the period of the transistor control signal 44. Thus the count is reset to zero after every two periods of this control signal, and provides a mean value of the frequency of occurrence of discharges in two periods. The set-point signal 38, 80 is set to a fixed voltage corresponding to a specified frequency of occurrence of the discharges (approximately 6 discharges per period in this case). The mark-space ratio of the control signal 44 increases progressively, causing an increase in the number of discharges detected at the output 78 of the comparator 52. The output signal 82 of the frequency meter 56 then increases progressively for each level, once for every two periods of the control signal. As long as the output signal 82 is lower than the set voltage 80 provided by the potentiometer 60, the output 84 of the controller 58 continues to rise, causing an increase in the mark-space ratio of the control signal, and then, when this output signal becomes equal to the set voltage, the output 84 of the controller becomes stabilized, and the system is locked to the desired number of discharges.

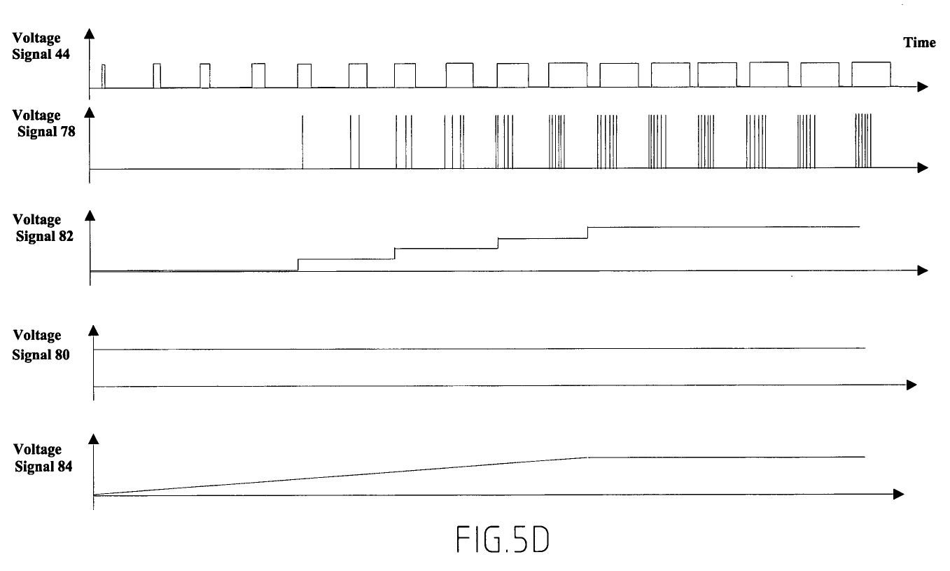

A variant embodiment of the plasma generation system is shown in detail in FIG. 6. In this embodiment, the current measurement system 32 is not formed by a simple resistance but is implemented in the form of a current transformer. This variant has the advantage of isolating the measurement circuits from the high voltage circuit and providing measurement at any desired point in this high voltage circuit. Thus FIG. 6 repeats the essential elements of FIG. 3 with their numbering, except for the current measurement system which is replaced by a new current measurement system 90. This consists of a ferrite 92, through which the conductor 22 carrying the high voltage passes, and which comprises a wire 94 wound in turns in the ferrite and serving to sample part of the current. One of the two ends of the wire is connected to earth, while the other end runs to the filter 50 of the conversion system 34 whose operation is identical to that described with reference to FIG. 3.

The inventors have also found that it is possible to obtain an identical result with a continuous high voltage supply. FIG. 7 shows the circuit diagram of the corresponding plasma generation system. The elements identical to those of FIG. 3, corresponding to an alternating high voltage, have the same references. By comparison with this first embodiment, the plasma source no longer comprises the dielectric 30, which can be used only in the alternating version, and the output 72 of the transformer 40 passes through a rectifier circuit 96, of the voltage doubling type for example, before passing through the source. This well-known system enables an alternating voltage of × V peak-to-peak to be transformed into a continuous voltage of 2*× V. The voltage 22 applied to the terminals of the source is therefore continuous and proportional to the amplitude of the output voltage 72 of the transformer 40. However, the electrical discharge processing circuit is identical to that of the preceding case, with the current measurement system 32, the conversion system 34 and the control system 36.

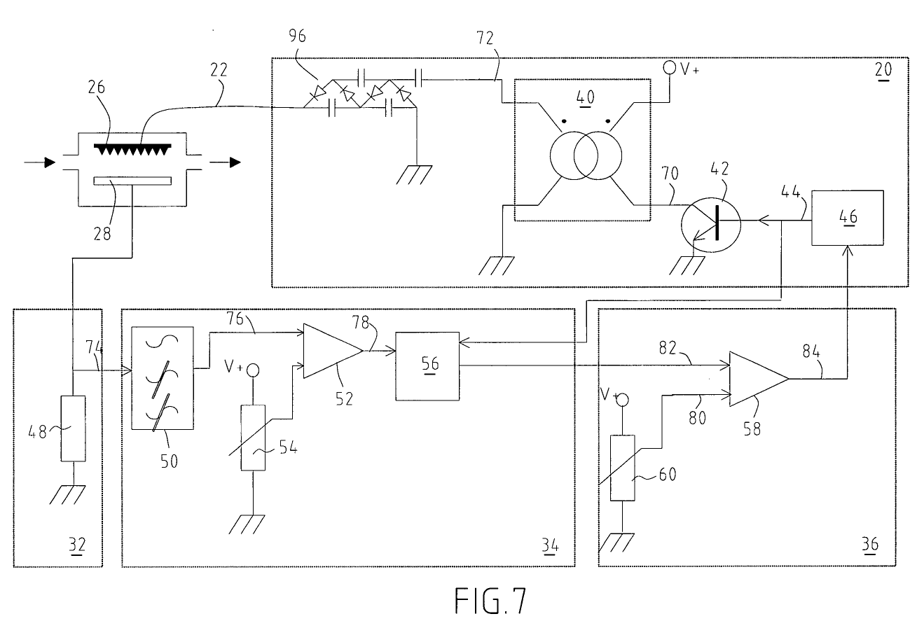

A variant embodiment of the invention based on a pulsed high voltage is illustrated in FIG. 8, which shows a circuit diagram of such an embodiment. The elements identical to those of the circuit of FIG. 3 have the same references.

In this case, the high voltage is a pulsed high voltage, in other words a positive high voltage VHT+ and a negative high voltage VHT−, having the same absolute value (5 kV for example), supplied by a high voltage chopper 98 whose output is connected to the electrode with a small radius of curvature 26 by the conductor 22. This chopper comprises, in a conventional way, two high voltage electronic switches (for example, high voltage optocouplers 100 and 102) driven, respectively, by the output signal 44 of the low voltage signal generator 46 and by the same signal inverted 104 by a logic gate 106.

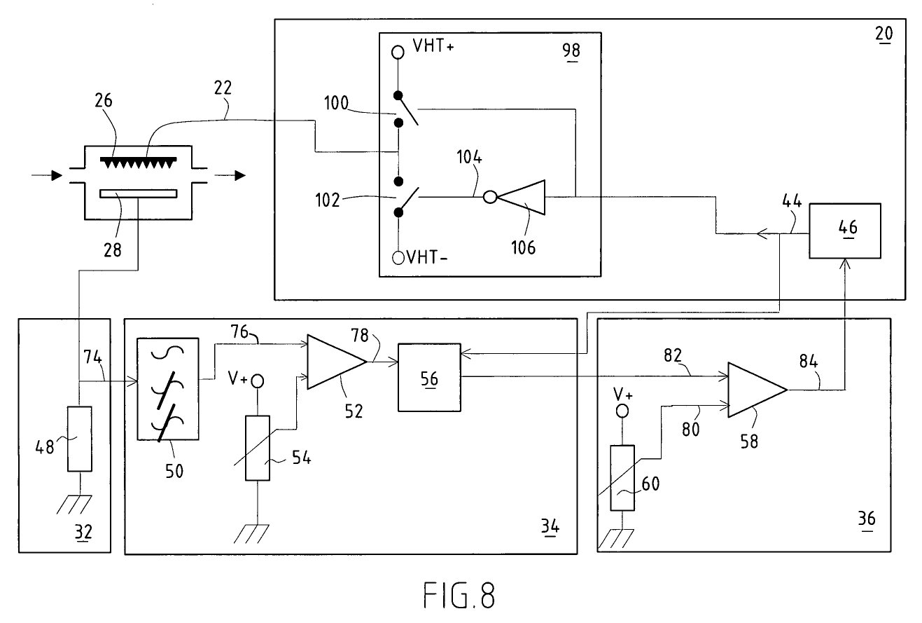

The different electrical signals that can be observed in this variant embodiment are shown on the oscillograms of FIGS. 9a to 9c, for different cases of mark-space ratio of the control signal 44. In this case, the voltage applied alternately to the electrode 26 is either VHT+ or VHT, with a ratio of the corresponding durations conforming to the mark-space ratio of the control signal 44, the duration of the level VHT+ determining the number of discharges which can occur between the electrodes. For example, for a voltage VHT+ of 5 kV, the following relations are found:
Mark-space ratio of 25%−>2 discharges per alternation.
Mark-space ratio of 50%−>4 discharges per alternation.
Mark-space ratio of 75%−>6 discharges per alternation.

As in the preceding embodiments, these discharges are read at the terminals of the resistance 48 and their number is then converted to a voltage 82 which is controlled with respect to the set voltage 80 according to the principle explained previously in relation to the flow chart of FIG. 5d.

1. A plasma generation system comprising a high voltage generator connected to at least two electrodes, one having a large radius of curvature while the other has a small radius of curvature, characterized in that said high voltage generator is controlled in such a way as to maintain constant the average frequency of occurrence of current discharges from the at least one electrode with a small radius of curvature to the at least one electrode with a large radius of curvature.

2. The plasma generation system as claimed in claim 1, characterized in that said electrode with a large radius of curvature has a plane geometry.

3. The plasma generation system as claimed in claim 1, characterized in that it additionally comprises a dielectric insulator inserted between the electrodes and in that said high voltage generator is a sinusoidal or pulsed alternating generator.

4. The plasma generation system as claimed in claim 3, characterized in that said high voltage generator comprises a high gain transformer driven by a transistor operating in switching mode under the control of a low voltage signal generator having a specified fixed frequency and a variable mark-space ratio.

5. The plasma generation system as claimed in claim 1, characterized in that it additionally comprises a resistance connected between an earth potential and the at least one electrode with a large radius of curvature, to measure a voltage representing the current discharges from the at least one electrode with a small radius of curvature to the at least one electrode with a large radius of curvature.

6. The plasma generation system as claimed in claim 1, characterized in that it additionally comprises a current transformer connected in the electrical circuit supplying the electrodes, to measure a current representing the current discharges from the at least one electrode with a small radius of curvature to the at least one electrode with a large radius of curvature.

7. The plasma generation system as claimed in claim 5, characterized in that it additionally comprises a high pass or band pass filter, so that only the part of said measured signal representing the discharges occurring between the electrodes is recovered.

8. The plasma generation system as claimed in claim 7, characterized in that the measured and filtered signal is converted by a conversion system, during a specified fixed period, into a specified continuous voltage representing a mean number of electrical discharges.

9. The plasma generation system as claimed in claim 8, characterized in that said measured mean number of discharges is maintained by a control system at a specified set value corresponding to said mean frequency of occurrence of the current discharges.

10. The plasma generation system as claimed in claim 3, characterized in that said high voltage generator comprises a high voltage chopper distributing, alternately, a positive continuous high voltage and a negative continuous high voltage to the at least one electrode with a small radius of curvature under the control of a low voltage signal generator with a specified fixed frequency and a variable mark-space ratio.

11. The plasma generation system as claimed in claim 1, characterized in that the high voltage generator is a continuous generator.

12. The plasma generation system as claimed in claim 11, characterized in that said high voltage generator comprises a rectifier circuit connected to the output of a high gain transformer driven by a transistor operating in switching mode under the control of a low voltage signal generator having a specified fixed frequency and a variable mark-space ratio.

13. A system for plasma sterilization in the presence of moisture, at atmospheric pressure and at ambient temperature, comprising a plasma generation system as claimed in claim 1.

14. The plasma generation system as claimed in claim 2, characterized in that it additionally comprises a dielectric insulator inserted between the electrodes and in that said high voltage generator is a sinusoidal or pulsed alternating generator.

15. The plasma generation system as claimed in claim 14, characterized in that said high voltage generator comprises a high gain transformer driven by a transistor operating in switching mode under the control of a low voltage signal generator having a specified fixed frequency and a variable mark-space ratio.

16. The plasma generation system as claimed in claim 6, characterized in that it additionally comprises a high pass or band pass filter, so that only the part of said measured signal representing the discharges occurring between the electrodes is recovered.

17. The plasma generation system as claimed in claim 16, characterized in that the measured and filtered signal is converted by a conversion system, during a specified fixed period, into a specified continuous voltage representing a mean number of electrical discharges.

18 The plasma generation system as claimed in claim 17, characterized in that said measured mean number of discharges is maintained by a control system at a specified set value corresponding to said mean frequency of occurrence of the current discharges.

19. The plasma generation system as claimed in claim 14, characterized in that said high voltage generator comprises a high voltage chopper distributing, alternately, a positive continuous high voltage and a negative continuous high voltage to the at least one electrode with a small radius of curvature under the control of a low voltage signal generator with a specified fixed frequency and a variable mark-space ratio.

20. The plasma generation system as claimed in claim 2, characterized in that the high voltage generator is a continuous generator.

21. The plasma generation system as claimed in claim 20, characterized in that said high voltage generator comprises a rectifier circuit connected to the output of a high gain transformer driven by a transistor operating in switching mode under the control of a low voltage signal generator having a specified fixed frequency and a variable mark-space ratio.

22. A system for plasma sterilization in the presence of moisture, at atmospheric pressure and at ambient temperature, comprising a plasma generation system as claimed in claim 2.

23. A system for plasma sterilization in the presence of moisture, at atmospheric pressure and at ambient temperature, comprising a plasma generation system as claimed in claim 2.

24. A system for plasma sterilization in the presence of moisture, at atmospheric pressure and at ambient temperature, comprising a plasma generation system as claimed in claim 4.

25. A system for plasma sterilization in the presence of moisture, at atmospheric pressure and at ambient temperature, comprising a plasma generation system as claimed in claim 5.

26. A system for plasma sterilization in the presence of moisture, at atmospheric pressure and at ambient temperature, comprising a plasma generation system as claimed in claim 6.

27. A system for plasma sterilization in the presence of moisture, at atmospheric pressure and at ambient temperature, comprising a plasma generation system as claimed in claim 7.

28. A system for plasma sterilization in the presence of moisture, at atmospheric pressure and at ambient temperature, comprising a plasma generation system as claimed in claim 8.

29. A system for plasma sterilization in the presence of moisture, at atmospheric pressure and at ambient temperature, comprising a plasma generation system as claimed in claim 9.

30. A system for plasma sterilization in the presence of moisture, at atmospheric pressure and at ambient temperature, comprising a plasma generation system as claimed in claim 10.

31. A system for plasma sterilization in the presence of moisture, at atmospheric pressure and at ambient temperature, comprising a plasma generation system as claimed in claim 11.

32. A system for plasma sterilization in the presence of moisture, at atmospheric pressure and at ambient temperature, comprising a plasma generation system as claimed in claim 12.

33. A system for plasma sterilization in the presence of moisture, at atmospheric pressure and at ambient temperature, comprising a plasma generation system as claimed in claim 14.

34. A system for plasma sterilization in the presence of moisture, at atmospheric pressure and at ambient temperature, comprising a plasma generation system as claimed in claim 15.

35. A system for plasma sterilization in the presence of moisture, at atmospheric pressure and at ambient temperature, comprising a plasma generation system as claimed in claim 16.

36. A system for plasma sterilization in the presence of moisture, at atmospheric pressure and at ambient temperature, comprising a plasma generation system as claimed in claim 17.

37. A system for plasma sterilization in the presence of moisture, at atmospheric pressure and at ambient temperature, comprising a plasma generation system as claimed in claim 18.

38. A system for plasma sterilization in the presence of moisture, at atmospheric pressure and at ambient temperature, comprising a plasma generation system as claimed in claim 19.

39. A system for plasma sterilization in the presence of moisture, at atmospheric pressure and at ambient temperature, comprising a plasma generation system as claimed in claim 20.

40. A system for plasma sterilization in the presence of moisture, at atmospheric pressure and at ambient temperature, comprising a plasma generation system as claimed in claim 21.
